(19) United States
(12) Patent Application Publication
(10) Pub. No.: US 2009/0298627 A1
(43) Pub. Date: Dec. 3, 2009

(54) Ventilated CVT

(76) Inventors: Barry A. Johnson, Roseau, MN (US); Greg G. Lislegard, Roseau, MN (US); Todd M. Zinda, Roseau, MN (US); Darin C. Saagge, Roseau, MN (US)

Correspondence Address: BAKER & DANIELS LLP, 300 NORTH MERIDIAN STREET, SUITE 2700, INDIANAPOLIS, IN, 46204, US

(21) Appl. No.: 10/946,897

(22) Filed: Sep. 22, 2004

Related U.S. Application Data
(63) Continuation-in-part of application No. 10/369,184, filed on Feb. 19, 2003, now Pat. No. 6,938,508.

(51) Int. Cl. F16H 57/04

(52) U.S. Cl. 474/93

(57) ABSTRACT

The invention provides apparatus for cooling at least one sheave and/or an endless belt of a continuously variable transmission (CVT). As previously mentioned, the CVT is comprised of a drive clutch, a driven clutch, and the endless belt disposed about the drive and driven clutches. Both the drive and driven clutches include an axially stationary sheave and an axially movable sheave. Certain embodiments provide a ventilation air path through at least one sheave of at least one clutch of the CVT. In addition, certain embodiments provide a ventilation air path through both sheaves of at least one clutch of the CVT. Further, certain embodiments provide apparatus adapted to direct air proximate to an outer face of at least one sheave of at least one clutch inward to a central area of the at least one sheave when the at least one sheave is rotated in a direction of rotation. The apparatus also allows the at least one sheave and at least one clutch to be more aerodynamic, enabling the CVT to operate more efficiently.

### CROSS REFERENCE TO RELATED APPLICATION

The present application is a continuation-in-part of, and claims priority to, US patent application filed Feb. 19, 2003 and assigned Ser. No. 10/369,184, the entire disclosure of which is incorporated herein by reference.

### FIELD OF THE INVENTION

The invention relates to continuously variable transmissions, such as those used in snowmobiles, and, in particular, to the drive and driven clutches that function thereon.

### BACKGROUND OF THE INVENTION

Split sheave continuously variable transmissions (CVTs) are used in a variety of recreational type off-road vehicles such as snowmobiles, all-terrain vehicles (ATVs), golf carts, and the like. CVTs, as their name implies, do not require shifting through a series of forward gears, but rather provide a continuously variable gear ratio that automatically adjusts as the vehicle speeds up or slows down, thus providing relatively easy operation for a rider. This automatic adjustment mechanism is advantageous to the rider because he need not be bothered by shifting gears for increasing or decreasing vehicle speed. However, this mechanism is also disadvantageous because, by its very function, the mechanism produces external stress to an endless belt that is utilized within the CVT. This external stress generally results in thermal breakdown of the belt, with the belt being torn apart or shredded.

Typically, CVTs are comprised of a drive clutch, a driven clutch, and the endless belt disposed about the clutches. The driven clutch includes a pair of opposed sheaves, which together define a generally V-shaped “pulley” within which the belt rides. The drive clutch is similarly configured with a pair of opposed sheaves.

As previously mentioned, while the operation of the CVT allows the rider to not be concerned with shifting gears, it also promotes external stress to the belt, eventually resulting in the belt breaking down and having to be replaced. While this is a well-known occurrence, it is also a general inconvenience for the rider, since he subsequently has to spend time and money buying and replacing the belt. If a CVT could be configured to somehow increase the operational lifetime of the belt running therein, it would be very beneficial to the rider and a valuable marketing tool for manufacturers of vehicles that utilize CVTs.

### BRIEF SUMMARY OF THE INVENTION

The invention provides apparatus for cooling at least one sheave and/or an endless belt of a CVT. As previously mentioned, the CVT is comprised of a drive clutch, a driven clutch, and the endless belt disposed about the drive and driven clutches. Both the drive and driven clutches include an axially stationary sheave and an axially movable sheave. Certain embodiments provide a ventilation air path through at least one sheave of at least one clutch of the CVT. In addition, certain embodiments provide a ventilation air path through both sheaves of at least one clutch of the CVT. Further, certain embodiments provide apparatus adapted to direct air proximate to an outer face of at least one sheave of at least one clutch inward to a central area of the at least one sheave when the at least one sheave is rotated in a direction of rotation. The apparatus also allows the at least one sheave and at least one clutch to be more aerodynamic, enabling the CVT to operate more efficiently.

Certain embodiments of the invention provide a continuously variable transmission. The transmission comprises a drive clutch rotatable about a first central axis and having an input shaft, a driven clutch rotatable about a second central axis and having an output shaft, and an endless belt disposed about the drive and driven clutches. The drive and driven clutches each are comprised of opposing sheaves including an axially stationary sheave and an axially movable sheave, and each sheave has an inner face and an outer face. The present embodiments optionally involve features described in the remainder of this paragraph. One of the sheaves is ventilated, and the ventilated sheave has a central hub extending axially from an inner face of the ventilated sheave towards an inner face of an opposing sheave of the ventilated sheave. The central hub has at least one bore therein. The outer face of the ventilated sheave has a recess therein, and a plate is secured over the recess. The plate has at least one aperture therein. A ventilation air path is defined through the plate via the at least one aperture and the ventilated sheave via the at least one bore.

Also, certain embodiments of the invention provide a continuously variable transmission. The transmission comprises a drive clutch rotatable about a first central axis and having an input shaft, a driven clutch rotatable about a second central axis and having an output shaft, and an endless belt disposed about the drive and driven clutches. The drive and driven clutches each are comprised of opposing sheaves including an axially stationary sheave and an axially movable sheave, and each sheave has an inner face and an outer face. The present embodiments optionally involve features described in the remainder of this paragraph. One of the sheaves is ventilated, and the ventilated sheave has one or more ribs extending axially from an outer face of the ventilated sheave. The one or more ribs generally curve away from a direction of rotation of the ventilated sheave as the one or more ribs extend in a radial direction from the central axis of the clutch containing the ventilated sheave. The curvature of the one or more ribs directs air inward to an area proximate to a central area of the outer face of the ventilated sheave when the ventilated sheave is rotated in the direction of rotation.

Further, certain embodiments of the invention provide a continuously variable transmission. The transmission comprises a drive clutch rotatable about a first central axis and having an input shaft, a driven clutch rotatable about a second central axis and having an output shaft, and an endless belt disposed about the drive and driven clutches. The drive and driven clutches each are comprised of opposing sheaves including an axially stationary sheave and an axially movable sheave, and each sheave has an inner face and an outer face. The present embodiments optionally involve features described in the remainder of this paragraph. One of the clutches is ventilated. The axially movable sheave of the ventilated clutch permits airflow therethrough via at least one bore therein, and the axially stationary sheave of the ventilated clutch permits airflow therethrough via at least one opening therein. The at least one bore of the axially movable sheave and the at least one opening of the axially stationary sheave at least partially overlap in all movable positions of the axially moveable sheave relative to the axially stationary sheave to provide a common airflow path through both the axially movable and axially stationary sheaves.

### BRIEF DESCRIPTION OF THE DRAWINGS

FIG. 1 is a perspective view of a snowmobile constructed in accordance with one embodiment of the invention;

FIG. 2 is a perspective view of an ATV constructed in accordance with one embodiment of the invention;

FIG. 3 is a top view of a continuous variable transmission;

FIG. 4 is a perspective view of the continuous variable transmission of FIG. 3;

FIG. 5 is a side view of an axially movable sheave of a driven clutch illustrating an exemplary embodiment of the invention;

FIG. 6 is a plan view of an outer face of the axially movable sheave of FIG. 5;

FIG. 7 is a cross-sectional side view of an exemplary embodiment of a driven clutch of the invention, showing an axially stationary sheave and the axially movable sheave of FIG. 5, and illustrating the movement of air through the axially movable sheave;

FIG. 8. is a perspective view of a driven clutch illustrating an exemplary embodiment of the invention;

FIG. 9 is a perspective view of an axially movable sheave of a driven clutch illustrating an exemplary embodiment of the invention;

FIG. 10 is a perspective view of a plate illustrating an exemplary embodiment of the invention;

FIG. 11 is a perspective view of a stationary movable sheave of a driven clutch illustrating an exemplary embodiment of the invention;

FIG. 12A is a perspective view of the axially movable sheave of FIG. 9 being in a first axial position with respect to the axially stationary sheave of FIG. 11 in an exemplary embodiment of the invention;

FIG. 12B is a perspective view of the axially movable sheave of FIG. 9 being in a second axial position with respect to the axially stationary sheave of FIG. 11 in an exemplary embodiment of the invention; and

FIG. 13 is an exploded perspective view of a driven clutch illustrating an exemplary embodiment of the invention.

### DETAILED DESCRIPTION OF THE INVENTION

The following detailed description is to be read with reference to the drawings, in which like elements in different figures have like reference numerals. The drawings, which are not necessarily to scale, depict selected embodiments, but are not intended to limit the scope of the invention. It will be understood that many of the specific details of the vehicle incorporating the system illustrated in the drawings could be changed or modified by one of ordinary skill in the art without departing significantly from the spirit of the invention. The function and operation of continuously variable transmissions (CVTs) are well known (see e.g., U.S. Pat. No. 3,861,229, Domaas, the teachings of which are incorporated herein by reference) and need not be described in detail. The CVT of the invention is designed for use on vehicles such as snowmobiles and ATVs, however it may be used on such other vehicles as golf carts and the like.

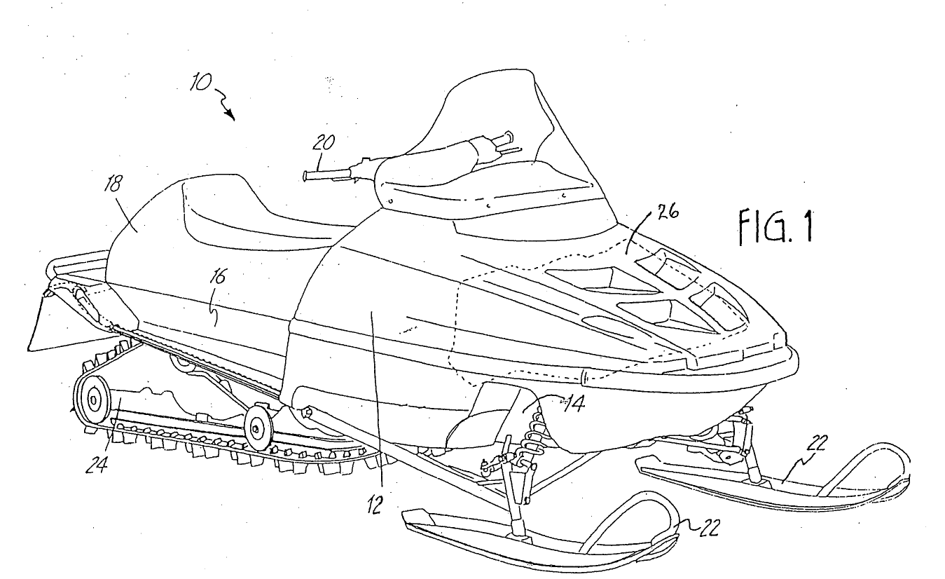

A snowmobile 10 having a system in accordance with one embodiment of the invention is illustrated in FIG. 1. The snowmobile 10 includes a body assembly 12 made up of a number of parts which may be formed of suitable materials that cover and protect a support frame or chassis 14. The body assembly 12 further includes a rear body portion 16 that accommodates a seat 18 adapted to carry one or more riders in straddle fashion. A handlebar assembly 20, positioned forwardly of the seat, is conventionally connected to a pair of front skis 22 for steering the snowmobile. The skis 22 are supported by a suitable front suspension system that is connected to the chassis 14. Rearwardly of the front skis 22 and beneath the seat 18, the chassis 14 suspends an endless track assembly 24 by a suitable suspension. The endless track 24 is driven by an internal combustion engine indicated generally by reference numeral 26 that is supported by the chassis 14 and located in an engine compartment within the body assembly 12 towards the front of the snowmobile 10. Positioned proximate to the engine, supported by the chassis 14, and located within the body assembly 12 is also a CVT (not shown).

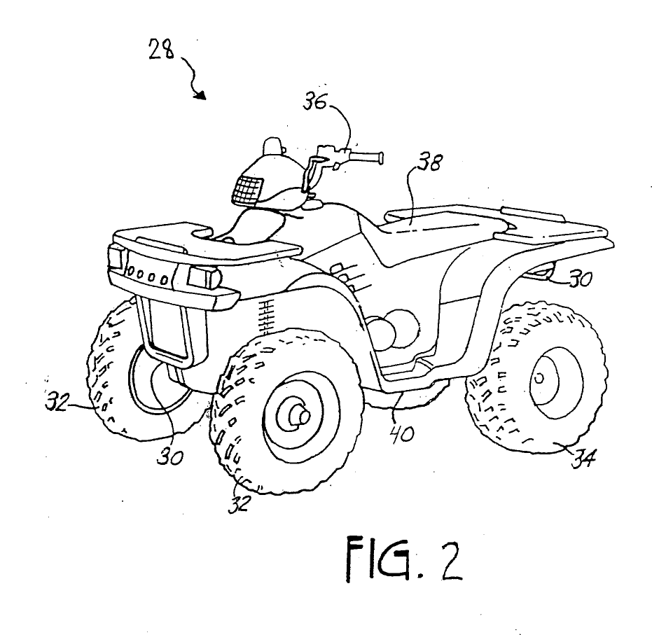

An ATV 28 having a system in accordance with one embodiment of the invention is illustrated in FIG. 2. The ATV includes a chassis, designated generally by reference numeral 30, to which the various systems and components of the vehicle are attached. These components include front wheels 32, rear wheels 34, handlebars 36 connected by a suitable steering linkage to the front wheels 32 for steering the vehicle, and a straddle-type seat 38 upon which the rider sits. An engine and a CVT are carried on the chassis 30, generally beneath the straddle-type seat 38 and substantially between a pair footrests (only the left footrest 40 is visible in FIG. 2).

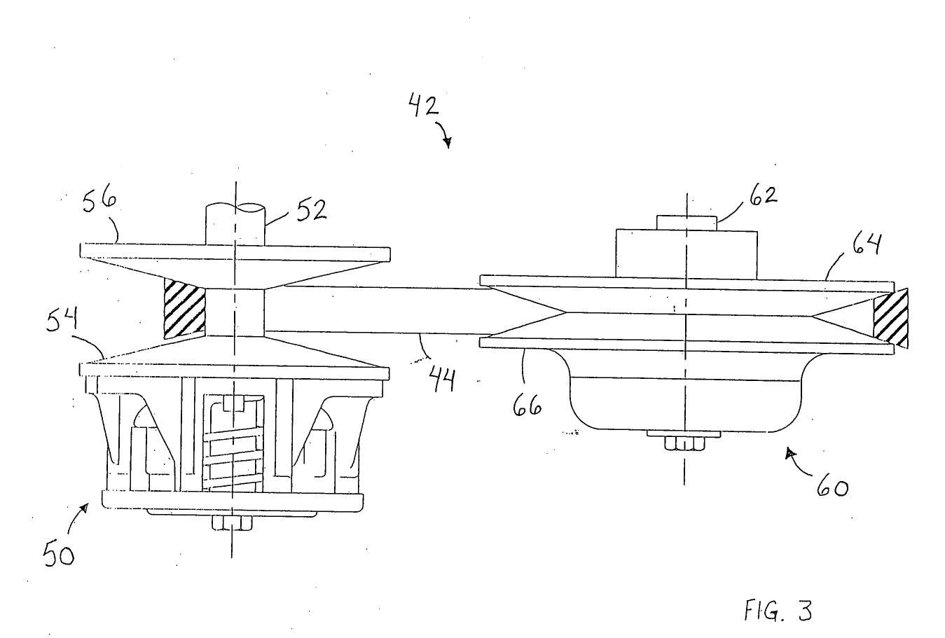

FIG. 3 illustrates the features of a CVT suitable for use with vehicles such as those described above. The CVT 42 includes a drive clutch 50 having a drive shaft 52, a driven clutch 60 having a driven shaft 62, and an endless belt 44 disposed about the drive and driven clutches 50 and 60 respectively. As indicated previously, the driven clutch 60 includes a pair of opposed sheaves which together define a generally V-shaped “pulley” within which the belt 44 rides. One of the sheaves 64 is axially movable (i.e., movable in the direction parallel to a central axis of the driven shaft 62), and the other sheave 66 is axially stationary. The drive clutch 50 is similarly configured with a pair of opposed sheaves, one being axially movable 54 and the other being axially stationary 56. The drive and driven clutches 50 and 60 respectively could very well be referred to as drive and driven clutch assemblies, as each clutch is actually an assembly of corresponding opposed movable and stationary sheaves. However, to avoid any confusion or inconsistency, the terms “drive clutch” and “driven clutch” will be used herein throughout. Also, when the terms “radial” or “radially” are used herein, the terms are generally in reference to a distance or orientation perpendicular to a central axis of one of the clutches (i.e., the central axis of either the drive shaft 52 or the driven shaft 62). In addition, when the terms “axial” or “axially” are used herein, the terms are generally in reference to a distance or orientation parallel to the central axis of one of the clutches.

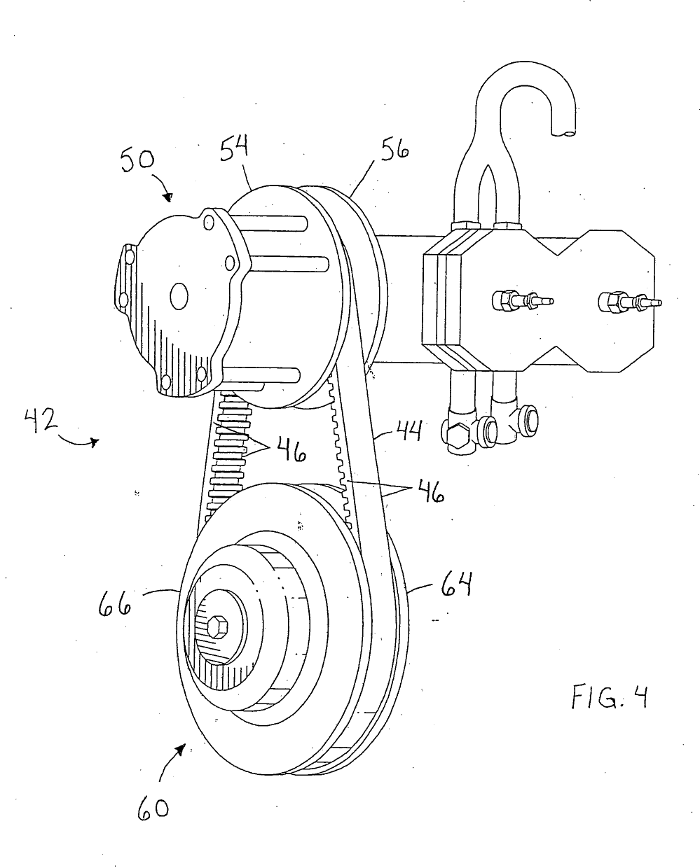

FIG. 4 is a perspective view of the CVT 42 of FIG. 1. The functioning of the CVT 42, in regards to the movement of the belt 44 about the drive clutch 50 and the driven clutch 60, is illustrated. The sheaves 54 and 56 of the drive clutch 50 are normally biased (such as by a spring) axially away from each other, and the sheaves 64 and 66 of the driven clutch 60 are normally biased axially toward each other (typically by a spring). When the vehicle is not in motion and the engine is started but not engaged, the drive clutch 50 rotates at idle speed, with the belt 44 positioned low in the V-shaped “pulley” of the drive clutch 50 and high in the V-shaped “pulley” of the driven clutch 60 (shown in FIG. 4). When the engine speed is increased above idle speed, a centrifugal mechanism in the drive clutch 50 causes the axially movable sheave 54 to move toward the axially stationary sheave 56, squeezing the belt 44 at contact surfaces 46. In turn, when the drive clutch 50 engages the belt 44, the belt 44 is subsequently rotated about the drive clutch 50 and the driven clutch 60 at an accelerated rate. Also, as the drive clutch 50 engages the belt 44, the belt 44 is pushed radially outwardly on the drive clutch. As a consequence, the belt 44 is pulled radially inwardly on the driven clutch 60, causing the axially movable sheave 64 of the driven clutch 60 to move axially away from the axially stationary sheave 66. Even though the belt 44 is typically comprised of a resilient material (e.g., rubber), the accelerated rotation of the belt 44, coupled with compressive forces exerted on the belt 44 sides by the axially movable sheave 64 and the axially stationary sheave 66 of the driven clutch 60, may cause a build-up of excessive heat on the belt 44. In particular, the build-up of heat may be quite high at the surfaces 46 where the belt 44 contacts with the axially movable sheave 64 and axially stationary sheave 66.

As previously mentioned, the material breakdown of the belt 44 is the net result of many factors, however, almost all of the factors tend to be derived from the belt 44 getting too hot, and essentially fatiguing to the point of breakdown. Therefore, in designing a CVT to increase the operational lifetime of the belt 44 that rides therein, it is believed that it would be best to create cooling in the driven clutch 60, in areas in contact with the belt 44 and in areas proximate to the belt 44. This cooling is done specifically by modifying the axially movable sheave 64 and axially stationary sheave 66 accordingly. However, it is also contemplated that these modifications could very well be applied in the case of the drive clutch assembly 50 and its corresponding sheaves 54 and 56. The exemplary embodiments that will be largely discussed will involve the driven clutch assembly 60. However, it is to be understood that the scope of the present invention is not limited to these exemplary embodiments.

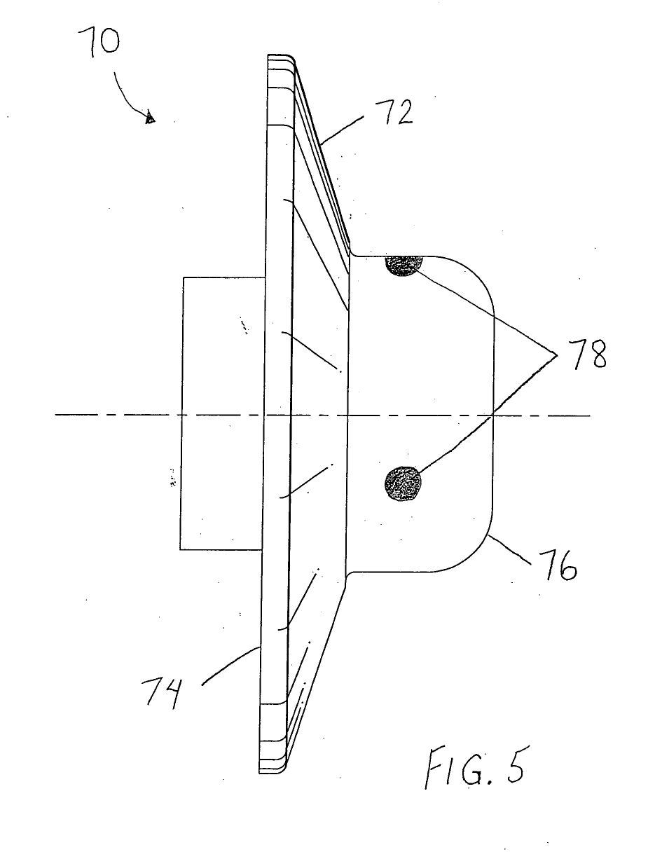

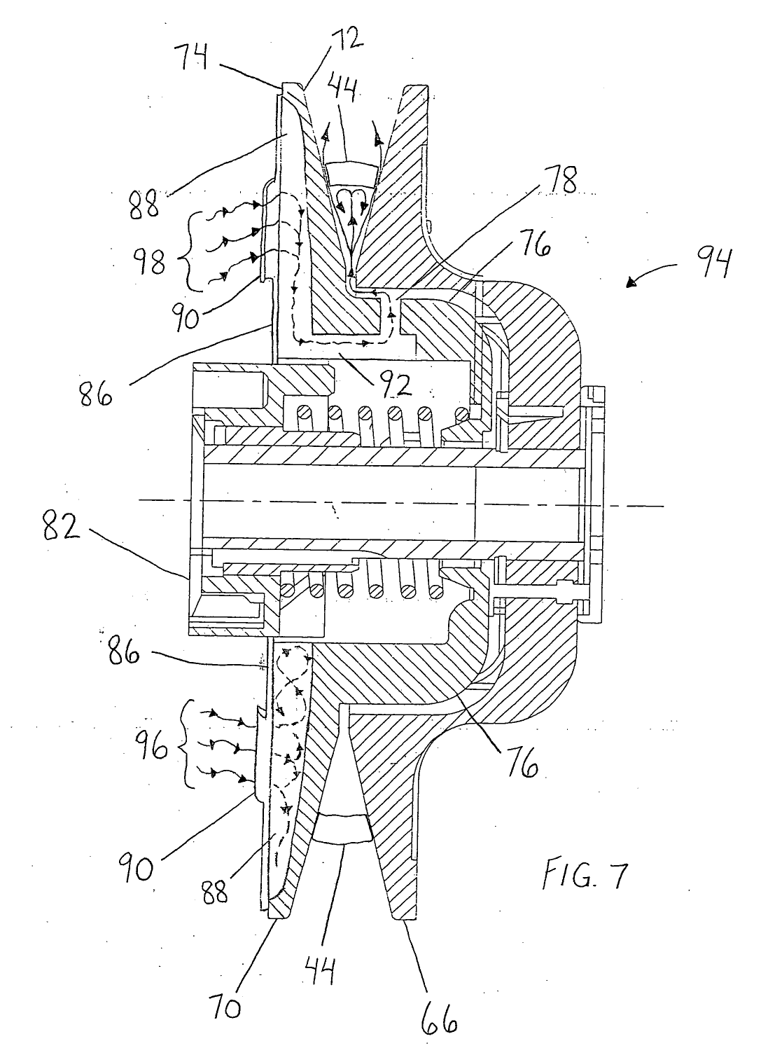

FIG. 5 is a side view of an axially movable sheave 70 of a driven clutch illustrating an exemplary embodiment of the invention. The axially movable sheave 70 has an inner face 72 and an outer face 74. A centrally located, generally rounded hub 76 extends axially from the inner face 72 of the sheave 70. In certain embodiments of this invention, the hub 76 includes at least one bore 78 running therethrough. Preferably, the at least one bore 78 is positioned along a side surface of the hub 76, and is oriented in a general radial direction from a central axis of the driven clutch. The number of bores 78 in the hub 76 is variable, and may be dependent on the specific design of the sheave 70, as will be discussed later. In certain embodiments, where a plurality of bores 78 are distributed about the central hub 76, the bores 78 are preferably distributed at generally equal angles about the respective central axis of the driven clutch. Each bore 78 is comprised of a generally circular aperture, and functions in expelling air that is funneled through the hub 76 from the outer face 74 of the sheave 70. As will be later illustrated with reference to FIG. 7, each bore 78 extends into the hub 76, through the axially movable sheave 70, and out the outer face 74 of the sheave 70.

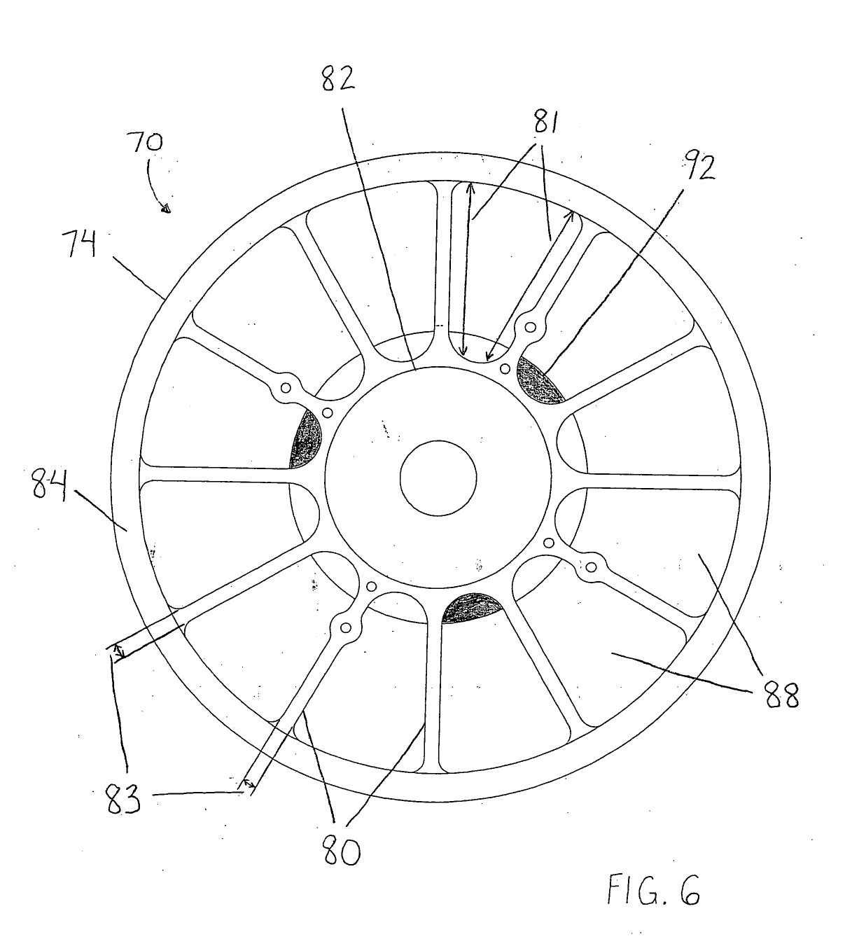

FIG. 6 is a plan view of the outer face 74 of the axially movable sheave 70 of FIG. 5. A plurality of ribs 80 extends axially from the outer face 74 of the sheave 70. As shown, each rib 80 comprises a thin, straight-walled member that has a length dimension 81 that exceeds its width dimension 83, and extends radially from an inner edge of the sheave 70 (adjacent to a cam 82 of the driven clutch) to an outer edge 84 of the sheave 70. Also, each rib 80 is a molded portion of the sheave 70, with an inner axial surface of each rib 80 being integrally joined with the outer face 74 of the sheave 70, and an outer axial surface of each rib 80 being exposed. Each rib 80 ramps in height from a maximum at an inner radial end extending from the inner edge of the sheave 70 (adjacent to the cam 82) down to a minimum at an outer radial end extending to the outer edge 84 of the sheave 70. The plurality of ribs 80 is spatially positioned around the outer face 74 of the sheave 70 in a windmill-like pattern, wherein each rib 80 is generally separated from adjacently-lying ribs 80 by a substantially equal sheave surface area.

A cover plate 86 (shown in FIG. 7) typically fits over and is secured to the outer face 74 of the axially movable sheave 70. The cover plate 86 is generally comprised of sheet metal, but can be comprised of other like materials as well. When the cover plate 86 is secured over the outer face 74 of the axially movable sheave 70, a plurality of generally radially oriented air chambers 88 is defined between the cover plate 86 and the axially movable sheave 70. The quantity of air chambers 88 is related to the quantity of ribs 80, which serve to separate the air chambers 88 from one another. The cover plate 86 is preferably sized to substantially cover the plurality of air chambers 88. However, in other certain embodiments, the cover plate 86 may perhaps be segmented to only cover ½, or even ¼ of the plurality of air chambers 88. It is even contemplated that the cover plate 86 may be configured to only cover one air chamber 88. In certain particularly preferred embodiments of the invention, the cover plate 86 has an outer diameter that is substantially equal to the outer diameter of the outer face 74 of the axially movable sheave 70, and an inner diameter sized such that the cover plate 86 fits around the cam 82 of the driven clutch.

The cover plate 86 further has on its outside surface, oriented away from the outer face 74 of the axially movable sheave 70, at least one air scoop 90 (two of which are shown in FIG. 7). The at least one air scoop 90 is oriented to face in a direction of rotation of the axially movable sheave 70, and is adapted to bring outside air into at least one of the plurality of air chambers 88. The at least one air chamber 88 located below the at least one air scoop 90 may utilize the outside air to cool the axially movable sheave 70. Alternatively, the at least one air chamber 88 located below the at least one air scoop 90 may further include at least one air channel 92 that is formed into a narrowed portion of the at least one chamber 88 of the axially movable sheave 70. In reference to FIGS. 5 and 6, each of the air channels 92 (FIG. 6) is adapted to fluidly communicate with a corresponding bore 78 in the hub 76 (FIG. 5). Thus, the air channels 92, along with the bores 78, the air chambers 88, and the air scoops 90, provide for airflow from the outer face 74 to the inner face 72 of the axially movable sheave 70.

FIG. 7 is a cross-sectional side view of a driven clutch 94 of the invention utilizing the axially movable sheave 70 of FIGS. 5 and 6 and the axially stationary sheave 66 of FIGS. 3 and 4. When the driven clutch 94 is incorporated into a CVT, and the CVT is subsequently engaged, the driven clutch 94 rotates along with the drive clutch (not shown) and the belt 44 rides between the two clutches. With the rotation of the driven clutch 94, both the axially stationary sheave 66 and the axially movable sheave 70 may rotate in unison. As previously discussed, as the rotation is accelerated, the belt 44 is pulled radially inward on the driven clutch assembly 94, causing the axially movable sheave 70 of the driven clutch 94 to move axially away from the axially stationary sheave 66. As a result, the at least one bore 78 in the hub 76 of the axially movable sheave 70 may slide out from underneath the axially stationary sheave 66. When the bore is uncovered, airflow out of the bore is maximized. In turn, the cooling function of the invention is most efficient. However, as shown in FIG. 7, there can be airflow even when the axially stationary sheave 66 is disposed over the at least one bore 78.

When the axially movable sheave 70 rotates, the air scoops 90 on the outer surface of the cover plate 86 come in contact with the air at the outer face 74 of the axially movable sheave 70. As one of the air scoops 90 hits the air, the air scoop 90 collects the air. Once inside the air scoop 90, the air generally is driven into the corresponding air chamber 88 of the sheave 70 that is located below the air scoop 90. Once inside the air chamber 88, the air does one of two things.

If the air chamber 88 is without the air channel 92, such as the chamber 88 on the lower portion of the axially movable sheave 70 illustrated in FIG. 7, incoming air 96 has no path to follow, and is subsequently pushed out of the air chamber 88 by other scooped air being brought in. In this scenario, the incoming air 96 is used to cool the axially movable sheave 70. If the chamber 88 has the air channel 92, such as the chamber 88 on the upper portion of the axially movable sheave 70 illustrated in FIG. 7, incoming air 98 flows from the chamber 88 and subsequently, through the channel 92, which originates at the narrowed portion of the chamber 88 and continues through the axially movable sheave 70. The incoming air 98 flows through the channel 92, and then out one of the bores 78 in the hub 76 extending from the inner face of the axially movable sheave 70. In summary, the incoming air 98 starts at the outer surface of the cover plate 86 and ends up at the inner face 72 of the axially movable sheave 70. Subsequently, the incoming air 98 is forced out of the hub 76 into an area defined by the inner surfaces of the sheaves 70 and 66 to the sides, the hub 76 below, and the belt 44 above. As the amount of air 98 accumulates in the area underneath the belt 44, the air 98 begins to be driven outside the area. For example, air may pass between the belt 44 and the inner faces of both the axially stationary sheave 66 and axially movable sheave 70. Thus, the air 98 that is circulated from the outer surface of the cover plate 86, through the sheave 70, and to the inner face 72 of the sheave 70 may act to cool the belt 44 as well as the environment proximate to the belt 44.

As illustrated in FIG. 7, the air 98 is channeled from the outer surface of the cover plate 86, through the axially moveable sheave 70, and to the inner face 72 of the sheave 70. In certain preferred embodiments, as detailed above, the air 98 travels through one of the air scoops 90 within the cover plate 86, into one of the air chambers 88 within the sheave 70, through the air channel 92 connected to the air chamber 88, and out one of the bores 78 contained in the hub 76. However, it is recognized that there are a variety of aspects that could be modified in channeling the air 98 from the outer face 74 of the sheave 70 to the inner face 72. For instance, it is disclosed that the incoming air 98 is collected by one of the air scoops 90 and driven into one of the air chambers 88. However, it is recognized that one of the air scoops 90 could instead drive the air 98 into a plurality of air chambers 88. On the other hand, a plurality of air scoops 90 could be utilized to drive the air 98 into a single air chamber 88. Finally, a plurality of air scoops 90 could be utilized to drive the air 98 into a plurality of air chambers 88. It is also detailed that the incoming air flows from an air chamber 88 to an air channel 92 located in the narrowed portion of the air chamber 88. Yet, it is recognized that the air chamber 88 could be connected to a plurality of air channels 92. In contrast, a plurality of air chambers 88 could be connected to a single air channel 92. Further, a plurality of air chambers 88 could be connected to a plurality of air channels 92. It is also mentioned that the air 98 is driven from the air channel 92 out through one of the bores 78 in the hub 76. Nevertheless, it is recognized that the air channel 92 could be connected to a plurality of bores 78 in the hub 76. In contrast, a plurality of air channels 92 could be connected to a single bore 78 in the hub 76. Finally, a plurality of air channels 92 could be connected to a plurality of bores 78 in the hub 76. In summary, a variety of ways may be used to transfer air from the outer surface of the cover plate 86 to the inner face 72 of the axially movable sheave 70 without deviating from the spirit and scope of the present invention.

In addition, while the at least one bore 78 is comprised of a circular aperture that is channeled to one of the air chambers 88 in the axially movable sheave 70 and remains a somewhat similar size throughout, it is fully contemplated that the at least one bore 78 may be of various other shapes or sizes and still be within the spirit of the invention. For example, each bore 78 may comprise a slot or rectangular shaped aperture and function just as well. Further, each bore 78 may vary in size from inlet opening at the air chamber 88 to outlet opening at the hub 76 such that the inlet is wider than the outlet, or the inlet is narrower than the outlet. Further, every bore 78 on the hub 76 may lead into substantially similarly sized conduits, or in contrast, every bore may lead into one of a plurality of differently sized conduits. While each bore 48 may not be described as such in the above-described embodiment, it is not done so as to limit the invention as such.

As previously discussed and illustrated in FIG. 4, as a vehicle accelerates, the rotation of the belt 44 is accelerated about the clutches 50 and 60. In addition, it has been mentioned that even though the belt 44 is comprised of a resilient material (e.g., rubber), the accelerated rotation, coupled with the compressive forces exerted on the belt 44 by the axially movable sheave 64 and the axially stationary sheave 66 of the driven clutch 60, may cause a build-up of excessive heat on the surfaces 46 of the belt 44 that contact the sheaves. Another consequence of the accelerated rotation of the belt 44 is that the belt may often slip on the inner faces of the sheaves of either clutch 50 or 60. This slippage generally causes a friction between the contact surfaces 46 of the belt 44 and the inner sheave faces of the clutches 50 and 60. This friction, in turn, generally causes a rise in temperature on the contact surfaces 46. If slippage between the belt 44 and the inner sheave faces of the clutches 50 and 60 occurs with enough frequency, the heat build-up on the belt contact surfaces 46 may lead to an overall breakdown of the belt 44.

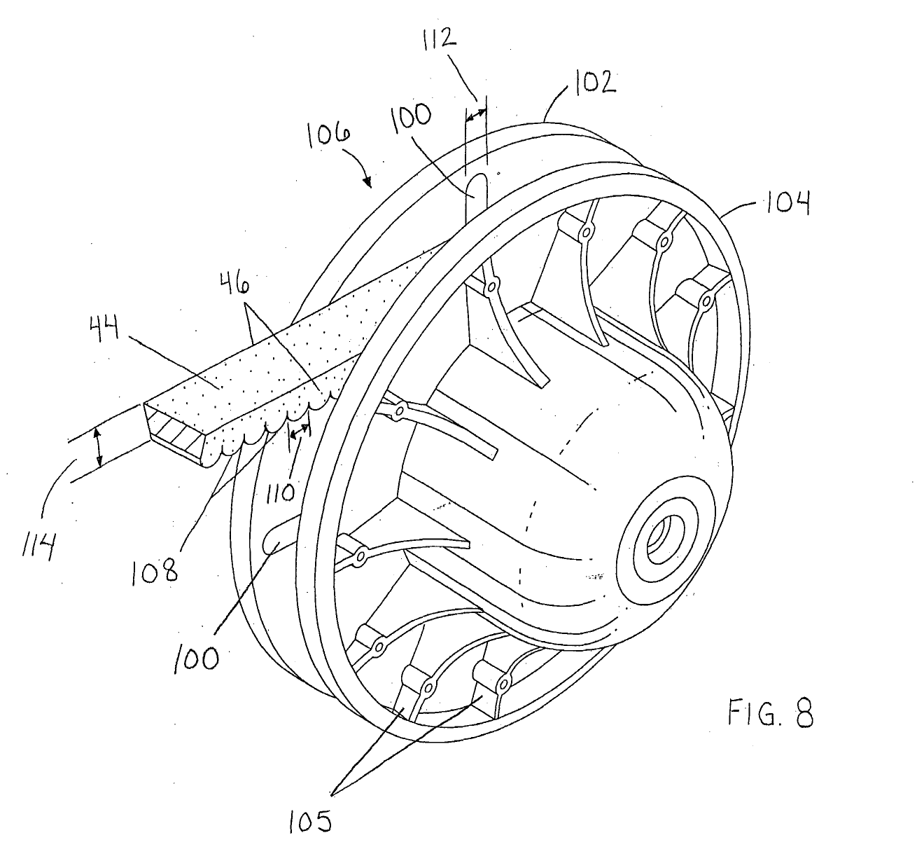

The problem of belt 44 slippage can be reduced with the addition of at least one recessed channel placed on the inner surface of at least one of the axially movable and axially stationary sheaves of either the drive or driven clutch. A driven clutch 106 illustrating an exemplary embodiment of the invention is shown in FIG. 8. In certain preferred embodiments, an axially movable sheave 102 may have one recessed channel 100 for every two ribs (not shown) located on the opposite side of the sheave 102. Although while also not shown, a similar quantity of recessed channels 100 may additionally be located on the inner surface of an axially stationary sheave 104 for a corresponding quantity of ribs 105 located on the opposite side of the sheave 104. Each of the recessed channels 100 is comprised of a slotted groove or indentation and is preferably positioned on the sheave surface such that it is generally oriented perpendicular to the rotating direction of the belt 44. In reference to the central axis of the clutch, each of the recessed channels 100 extends radially from the axis. Each recessed channel 100 extends to an axial depth in the inner surface of the respective sheaves 102 and 104 without breaking through to the outer surfaces of the sheaves 102 and 104. Preferably, each recessed channel 100 remains a constant size throughout. In particularly preferred embodiments, the recessed channels 100 have side walls that are configured to be substantially perpendicular to the inner surface of the respective sheave.

In certain embodiments, the recessed channels 100 are positioned on the axially stationary sheave 104 to correspond to the positioning of the recessed channels 100 on the axially movable sheave 102 such that each corresponding pair of recessed channels 100 function together, as will be discussed. Much like a studded belt provides reduced-slip traction for a snowmobile in the snow, the recessed channels 100 on the sheaves 102 and 104 provide for similar reduced-slip traction between the belt 44 and the inner faces of the sheaves 102 and 104. Specifically, as the contact surfaces 46 of the belt 44 rotate into contact with the inner faces of the sheaves 102 and 104, outer edges of curved portions 108 (i.e., teeth) on the sides of the belt 44 are temporarily inserted into the recessed channels 100 (due to the compressive forces applied against the resilient belt 44 by the opposing sheave faces), forming a temporary coupling between the belt 44 and at least one of the sheaves 102 and 104. With the recessed channels 100 being configured with side walls substantially perpendicular to the inner surface of the respective sheave, the channels 100 are adapted such that one of the curved portions 108 of the belt 44 will not easily slide out of the corresponding recessed channel 100. In turn, with the temporary coupling, as the belt 44 is rotated about the sheaves 102 and 104, the belt 44 is less likely to slip across the inner surfaces of the sheaves 102 or 104 as previously described. With less belt 44 slippage, less frictional heat is generated.

However, as previously mentioned and illustrated in FIG. 7, the expelled air 98 from the hub 76 is intended to not only cool the lower surface of the belt 44, but also to pass between the belt 44 and the inner faces of the sheaves 102 and 104 to cool the other surfaces of the belt 44 as well as the environment proximate to the belt 44. With reduced slippage between the belt 44 and the inner surfaces of the sheaves 102 and 104, it would seem that there is less chance for the air 98 to pass therebetween. Yet, this potential problem is remedied by sizing the recessed channels 100 accordingly. By their design (i.e., length, width, and depth), the recessed channels 100 provide for the expelled air 98 from the hub 76 to be passed from an inner radial end to an outer radial end of the recessed channels 100, and in so doing, to be passed around the belt contact areas 46. As illustrated in FIG. 8, the curved portions 108 on the inner side of the belt 44 are substantially similar in width 110 to the width 112 of the recessed channels 100. Therefore, when the curved portions 108 of the belt 44 and the corresponding recessed channels 100 couple, one of the curved portions 108 will generally be inserted into one of the corresponding recessed channels 100. The recessed channels 100 are of a length, i.e., radial distance, that is greater than the thickness dimension 114 of the belt 44, i.e., the radial distance measured from an inner radial end to an outer radial end of the endless belt. Thus, the contact surfaces 46 of the belt 44 will not entirely block any of the recessed channels 100 when the belt contacts the inner face of the corresponding sheave. Further, the recessed channels 100 are of a great enough axial depth such that the expelled air 98 can pass from the inner radial end to the outer radial end of the recessed channels 100 without being impeded by the insertion of the curved portion 108 of the belt 44. In summary, by sizing the recessed channels 100 appropriately, one may not only provide a direct source for cooling the belt 44 and its proximate environment by allowing air to pass freely between the belt and the sheave surfaces 102 and 104, but also may provide an indirect source for cooling the belt 44 by reducing the amount of heat build-up on the belt itself in reducing slippage.

In addition, it is contemplated that the recessed channels 100 may function in cooling the belt 44 as well as the environment proximate to the belt 44 without the presence of the at least one bore 78 in the hub 76. It is recognized that the recessed channels 100, by their previously described design (i.e., length, width, and depth), may allow for adequate airflow from the area above the belt 44 (i.e., defined as the environment outside the clutch 106) to the area underneath the belt 44 (i.e., defined by the inner surfaces of the sheaves 102 and 104 to the sides, the hub 76 below, and the belt 44 above), and vice versa. As the driven clutch 106 rotates, the at least one recessed channel 100, located on at least one of the inner faces of the axially movable or axially stationary sheaves 102 and 104 respectively, can very well contact the air in the area above the belt 44 and subsequently channel the air to the area underneath the belt 44. As this process is repeated over and over by the continuing rotation of the driven clutch 106, the air channeled to the area underneath the belt 44 will accumulate to an excessive amount for the area. In turn, this would result in the at least one recessed channel 100 having an exhaustive effect as well by forcing the air outward from the area underneath the belt 44 to the area above the belt 44. As such, by providing the recessed channels 100 without the presence of the at least one bore 78 in the hub 76, one may not only provide a direct source for cooling the belt 44 and its proximate environment by allowing air to pass freely between the area above the belt 44 and the area below the belt 44, but also may provide an indirect source for cooling the belt 44 by reducing the amount of heat build-up on the belt itself in reducing slippage.

While in certain preferred embodiments, as described above, each of the recessed channels 100 is comprised of a slotted groove with certain width, length, and depth in the respective sheaves 102 and 104 and remains a constant size throughout, it is fully contemplated that the recessed channels 100 may be of various shapes or sizes and still be within the spirit of the invention. For example, each recessed channel 100 may be circular or rectangular is shape and function just as well. Further, each recessed channel 100 may comprise an outline of a shape, such as a circle or rectangular, and function just as well. Also, it is contemplated that each recessed channel may have differing widths 112 (i.e., larger or smaller than the outer width 110 of the curved portion 108 of the belt 44), differing radial lengths (i.e., equal to or smaller than the radial thickness 114 of the belt 44), and differing axial depths (i.e., not enabling air to pass from the inner radial end to the outer radial end of the recessed channels 100, or vice versa if applicable, because of being impeded by the insertion of the curved portion 108 of the belt 44). In this same light, it is contemplated each recessed channel 100 may vary in size from inner radial end to outer radial end such that the inner radial end is wider than the outer radial end, or the inner radial end is narrower than the outer radial end. Further, it is contemplated that each recessed channel 100 may not extend across the inner surface of a respective sheave in a straight, radial direction from the axis of the clutch, but may be angled, curved, or even segmented from the axis instead. While these differing shapes, sizes, and orientations for the recessed channels would generally still enable the sheaves to have non-slip surfaces, they are not included as a preferred embodiment of the invention since these differing shapes, sizes, and orientations may compromise the airflow efficiency through the recessed channels 100, as well as the efficiency of their non-slip function. However, it is not done so as to limit the invention as such. Further, the recessed channels 100 could be referenced with many different terms, such as indentations, grooves, cavities, pits, and the like. While the term “recessed channel” is used herein, it is recognized that different terms could have been used without deviating from the spirit and scope of the present invention.

In addition, the recessed channels 100 on any one sheave may all be comprised of similarly sized and oriented grooves as described above, however, in contrast, the channels 100 may also be comprised of a plurality of differently sized and oriented grooves. Finally, the number of recessed channels 100 per sheave may vary. While it is described that there is preferably at least one recessed channel 100 for every two ribs 105 on the disclosed sheaves, it is also contemplated having at least one recessed channel 100 for every rib 105 on the sheave as well as having a lesser number of recessed channels 100, including a contemplated embodiment of having only one recessed channel 100 on one of the sheaves. While each recessed channel 100 may not be described as such in the above-described embodiment, it is not done so as to limit the invention as such.

As previously mentioned, in reference to FIG. 4, the material breakdown of the belt 44 is the net result of many factors, however, almost all of the factors tend to be derived from the belt 44 getting too hot, and essentially fatiguing to the point of breakdown. In addition to designing a CVT which in its use is used to directly cool the belt 44 as described above, it should be appreciated that variations can be made with respect to the design in which a path for airflow is created through the respective clutch. In turn, one can provide airflow so as to not only cool the belt 44 directly, but also to cool the belt indirectly by cooling at least one of the clutches (and its respective sheaves). As a result, airflow can be directed through at least one of the clutches of the CVT to provide cooling for the clutch, not only in areas in contact with the belt 44 and in areas proximate to the belt 44, but also in other areas so as to provide cooling of the clutch itself. In certain embodiments, this cooling is done by modifying at least one of the axially movable sheave 64 and axially stationary sheave 66 of the driven clutch assembly 60 accordingly. However, it is also contemplated that these modifications could instead, or in combination, be applied in the case of the drive clutch assembly 50 and at least one of its corresponding sheaves 54 and 56. The exemplary embodiments that will be largely discussed will involve the driven clutch assembly 60. However, it is to be understood that the scope of the invention is not limited to these exemplary embodiments.

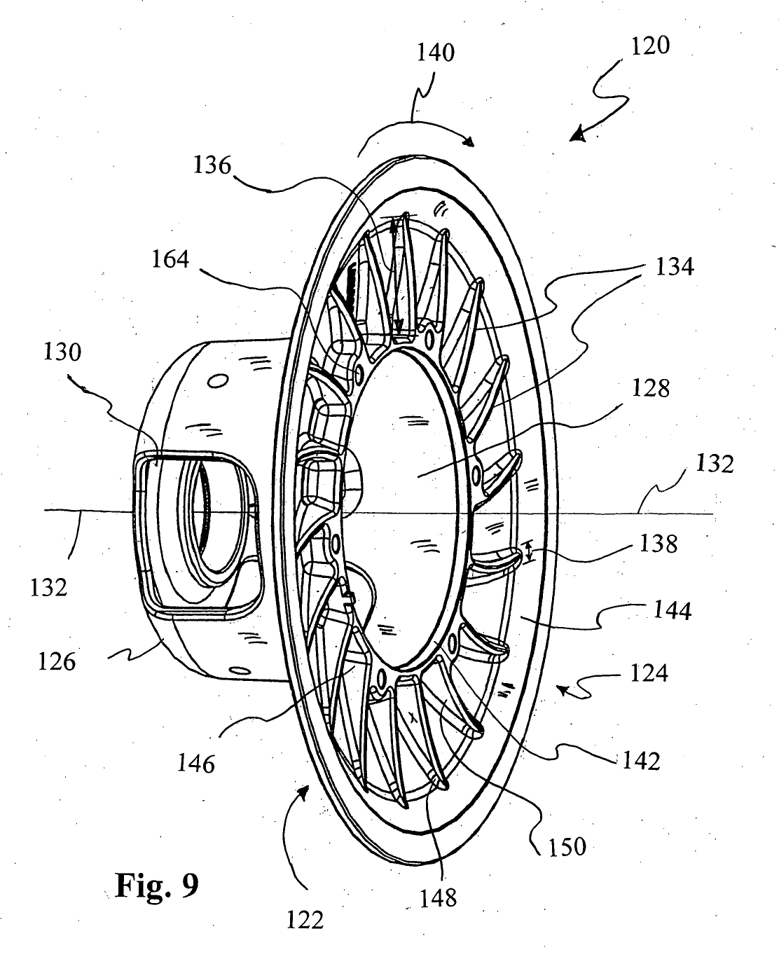

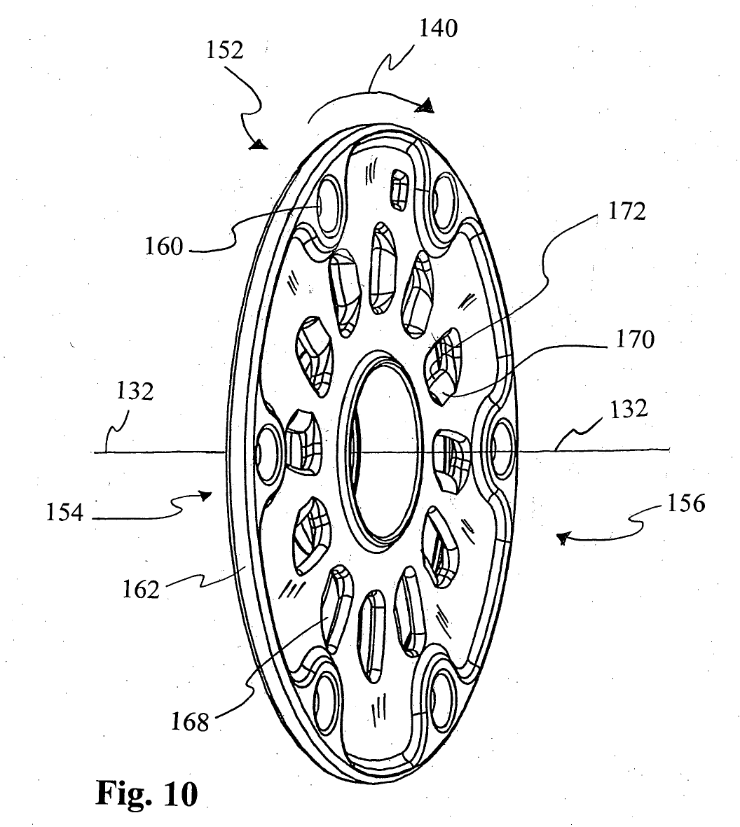

FIG. 9 is a perspective view of an axially movable sheave 120 of a driven clutch illustrating an exemplary embodiment of the invention. The axially movable sheave 120 has an inner face 122 (not visibly shown) and an outer face 124. A centrally located, generally rounded hub 126 extends axially from the inner face 122 of the sheave 120. Consequently, a recess 128 is formed by the hub 126, extending axially from the outer face 124 of the sheave 120. In certain embodiments, the hub 126 defines at least one bore 130 running therethrough. In certain embodiments, the at least one bore 130 is defined in a surface of the central hub 126, wherein such hub surface extends in a direction that varies from a central axis 132 of the driven clutch by between about 0° and about 45°. As such, if the hub surface extended in a direction that varied by about 0° from the central axis of the driven clutch, the hub surface would extend in a direction that is generally parallel with the central axis 132 of the driven clutch. In certain embodiments, the at least one bore 130 is oriented to permit airflow therethrough in a generally radial direction from the central axis 132 of the driven clutch. The number of bores 130 in the hub 126 can be varied as desired, and is dependent on the specific design of the sheave 120. In certain embodiments, the number of bores 130 is at least about one; however, in other certain embodiments, the number of bores 130 is at least about two. In further certain embodiments, the number of bores 130 is at least about three. If the central hub 126 has a plurality of bores 130, the bores 130, in certain embodiments, are symmetrically distributed at generally equal angles about the central axis 132 of the driven clutch. In certain embodiments, the at least one bore 130 is shaped to be generally rectangular. However, it should be appreciated that the at least one bore 130 can also be other shapes, including but not limited to, circular, oval, elliptical, etc. Further, if the central hub 126 has a plurality of bores 130, the bores 130 do not all have to be limited to one shape, but instead, can each be one or more of a plurality of shapes, including but not limited to, rectangular, circular, oval, elliptical, etc. In certain embodiments, the at least one bore 130 is adapted to generally exhaust air from the sheave 120, including any air that enters the sheave 120 from the outer face 124 of the sheave 120. As will be later illustrated with reference to FIGS. 10-13, the air received from the outer face 124 of the sheave 120, in certain embodiments, flows across the recess 128, and subsequently exits through the bore 130 in the hub 126.

In certain embodiments, as shown in FIG. 9, the axially movable sheave 120 will include one or more ribs 134 protruding axially from the outer face 124 of the sheave 120. The number of ribs 134 protruding from the sheave 120 can be varied as desired, and is dependent on the specific design of the sheave 120. As shown, each rib 134 is a thin member that has a length dimension 136 that exceeds its width dimension 138. As such, the outer face 124 of the sheave 120 can accommodate a large quantity of ribs 134, the inclusion of which increases the surface area of the sheave 120, and in turn, provides a better heat-sink for the sheave 120. In certain embodiments, the number of ribs 134 is at least about two; however, in other certain embodiments, the number of ribs 134 is at least about six. In further certain embodiments, the number of ribs 134 is at least about ten. During its typical use in the driven clutch of the CVT (not shown), the sheave 120 rotates in a clockwise direction 140 as observed from the sheave's outer face 124. As the one or more ribs 134 extend radially from an inner radial edge 142 of the sheave 120 to an outer radial edge 144 of the sheave 120, at least one of the one or more ribs 134 generally curves away from the direction of rotation 140 of the sheave 120. In certain embodiments, each of the one or more ribs 134 generally curves away from the direction of rotation 140 of the sheave 120 in this fashion. Each of the one or more ribs 134 is generally a molded portion of the sheave 120, with an inner axial surface of each rib 134 being integrally joined with the outer face 124 of the sheave 120, and an outer axial surface of each rib 134 being exposed. In certain embodiments, the one or more ribs 134 each ramp from a maximum height at an inner radial end 146 (e.g., extending from the inner radial edge 142 of the sheave 120) down to a minimum height at an outer radial end 148 (e.g., extending to the outer radial edge 144 of the sheave 120).

If the outer face 124 of the sheave 120 has a plurality of ribs 134, in certain embodiments, the ribs 134 are spatially positioned around the sheave 120 in a windmill-like pattern, wherein each rib 134 is generally separated from adjacently-lying ribs 134 by a substantially equal sheave surface area. By their design, the one or more ribs 134 are adapted to direct air surrounding the outer face 124 of the sheave 120 inward, so that the air accumulates at an area proximate to a central area of the outer face 124 of the sheave 120. At the same time, the design of the one or more ribs 134 also effectively reduces the wind drag that the ribs 134 experience when the sheave 120 rotates so as to increase the efficiency of the CVT. For example, when the CVT is engaged and the driven clutch rotates (with the axially movable sheave 120 rotating in the clockwise direction 140 as observed from the sheave's outer face 124), a leading surface 150 of each rib 134 makes contact with air located proximate to the outer face 124. However, because of their ramped height, the one or more ribs 134 experience minimum wind drag. At the same time, the one or more ribs 134, via their rotation and their curvature, naturally create an airflow for the air proximate to the outer face 124 of the sheave 120 so that the air is pulled inward proximate to the central recess 128 of the sheave 120. As a result, the design of the ribs 134 generally provides a funneling of air inward while creating a minimum amount of wind drag on the sheave 120. Further, the wind drag exerted on the ribs 134 is less than what would normally be encountered with ribs that are axially straight (e.g., not ramped) or radially straight (e.g., not curved) in orientation, or ribs that generally curve into the direction of rotation 140 of the sheave 120. In summary, a driven clutch using the sheave 120 with the ribs 134 is more aerodynamic, and as such, would rotate more efficiently, requiring less horsepower for rotation and exerting less stress on a corresponding CVT that the driven clutch is mounted onto.

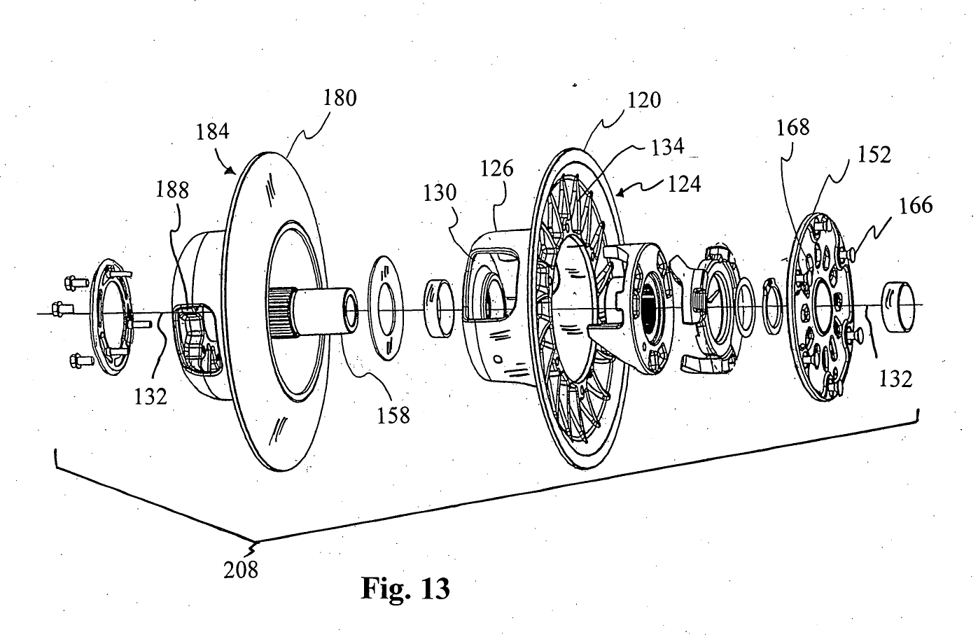

In certain embodiments, a plate 152 (shown in FIG. 10) is secured to the outer face 124 of the axially movable sheave 120. The plate 152 has an inner face 154 (not visibly shown) and an outer face 156. The plate 152 is generally formed from sheet metal; however, the plate can also be formed from other like materials instead of, or in combination with, sheet metal. The plate 152 is generally circular in shape, and in certain embodiments, generally sized to substantially cover the recess 128 of the outer face 124 of the sheave 120. However, it should be appreciated that the plate 152 can also be other shapes, including but not limited to, oval, elliptical, square, rectangular, etc. Additionally, in other certain embodiments, the plate 152 is configured to cover at least ½ of the recess 128. In other certain embodiments, the plate 152 is configured to cover at least ¼ of the recess 128. In certain embodiments, the plate 152 has an outer diameter that is substantially equal to the outer diameter of the recess 128 of the axially movable sheave 120, and an inner diameter sized such that the plate 152 fits around the axle 158 of a driven clutch (depicted in FIG. 13). In certain embodiments, the plate 152 defines one or more holes 160 located proximate to its outer edge 162. These holes 160 align with corresponding bosses 164 (shown in FIG. 9) defined in the axially movable sheave 120 and located proximate to its inner edge 142. Fasteners 166 (shown in FIG. 13) are then inserted in the holes 160 and corresponding bosses 164 and used to secure the plate 152 to the sheave 120. It should be appreciated that other securing devices can also be used instead of, or in combination with the fasteners 166, including but not limited to, adhesives, clamps, clips, etc.

The plate 152 also defines at least one aperture 168. In certain embodiments, the at least one aperture 168 is defined in a major surface of the plate 152, wherein such major surface extends in a direction that varies from the central axis 132 of the driven clutch by between about 45° and about 90°. As such, if the major surface of the plate 152 extended in a direction that varied by about 90° from the central axis 132 of the driven clutch, the major surface would extend in a direction that is generally perpendicular to the central axis 132 of the driven clutch. In certain embodiments, the at least one aperture 168 is oriented to permit airflow therethrough in an axial direction generally similar to the central axis 132 of the driven clutch. The number of apertures 168 can be varied as desired, and is dependent on the specific design of the plate 152. In certain embodiments, the number of apertures 168 is at least about two; however, in other certain embodiments, the number of apertures 168 is at least about six. In further certain embodiments, the number of apertures 168 is at least about ten. In certain embodiments, each aperture 168 is shaped to be generally rectangular. However, it should be appreciated that the at least one aperture 168 can also be other shapes, including but not limited to, circular, oval, elliptical, etc. Further, if the plate 152 has a plurality of apertures 168, the apertures 168 do not all have to be limited to one shape, but instead, can each be one or more of a plurality of shapes, including but not limited to, rectangular, circular, oval, elliptical, etc.

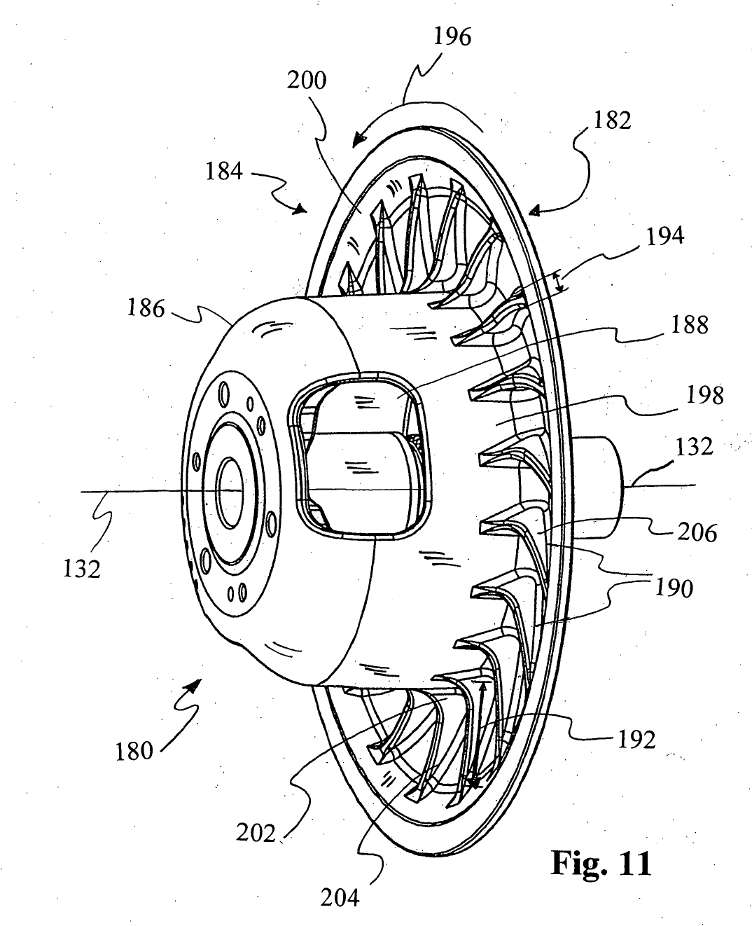

When the plate 152 is secured onto the axially movable sheave 120, the at least one aperture 168 is adapted for enabling air to flow from the outer face 156 of the plate 152 therethrough, and in certain embodiments, into the recess 128 of the sheave 120. The air can be directed as such via the design of the aperture 168 and the normal functioning of a driven clutch. For example, when the plate 152 is secured to the sheave 120, and the sheave 120 is rotated as part of the driven clutch of a CVT, the plate 152 is also rotated in a similar direction 140 (clockwise as observed from the plate's outer face 156). The at least one aperture 168 is partially defined by a leading surface leading the at least one aperture 168 in the direction of rotation 140 of the sheave 120. The leading surface is designed to have a “fin” design. Specifically, the first portion 170 of the leading surface extends opposite the direction of rotation while also extending axially inward from the outer face 156 of the plate 152 so as to form a ramped curvature. As the plate 152 is rotated in the clockwise direction 140, this ramped curvature enables the air to flow freely into the at least one aperture 168. In certain embodiments, the first portion 170 of the leading surface subsequently flattens out to a second portion 172 so that air can flow through the plate 152 in a direction generally similar to the central axis 132 of the driven clutch. As the sheave 120 rotates in the clockwise direction 140, the “fin” design, in certain embodiments, enables the air directed through the at least one aperture 168 to further circulate across the recess 128 of the sheave 120. In addition, with the sheave 120 moving axially with respect to the stationary sheave, additional air is directed through the at least one aperture 168. In particular, as the sheave 120 of the driven clutch moves axially away from the stationary sheave in the clutch's normal operation, the plate 152 contacts air located proximate to the outer face 124 of the sheave 120. A portion of the air will be driven into the driven clutch through the at least one aperture 168 defined by the plate 152. In summary, with the at least one aperture 168 defined in the plate 152, air is made to circulate from the outer face 124 of the sheave 120 into, and in certain embodiments, through the driven clutch.

Where the air, directed through the at least one aperture 168 in the plate 152, ultimately circulates depends on the positioning of the axially movable sheave 120 with respect to the axially stationary sheave in the driven clutch. FIG. 11 is a perspective view of an axially stationary sheave 180 of a driven clutch illustrating an exemplary embodiment of the invention. The axially stationary sheave 180 has an inner face 182 (not visibly shown) and an outer face 184. Similar to the axially moveable sheave 120 of FIG. 9, a centrally located, generally rounded hub 186 extends axially from the sheave 180. The hub 186 extends from the outer face 184 of the sheave 180. Like the sheave 120 of FIG. 9, the hub 186 includes at least one opening 188 running therethrough. In certain embodiments, the at least one opening 188 is defined in a surface of the central hub 186, wherein such hub surface extends in a direction that varies from the central axis 132 of the driven clutch by between about 0° and about 45°. As such, if the hub surface extended in a direction that varied by about 0° from the central axis 132 of the driven clutch, the hub surface would extend in a direction that is generally parallel with the central axis 132 of the driven clutch. In certain embodiments, the at least one opening 188 is oriented to permit airflow therethrough in a generally radial direction from the central axis 132 of the driven clutch. The number of openings 188 in the hub 186 can be varied as desired, and is dependent on the specific design of the sheave 180. In certain embodiments, the number of openings 188 is at least about one; however, in other certain embodiments, the number of openings 188 is at least about two. In further certain embodiments, the number of openings 188 is at least about three. If the central hub 186 has a plurality of openings 188, the openings 188, in certain embodiments, are symmetrically distributed at generally equal angles about the central axis 132 of the driven clutch. In certain embodiments, the at least one opening 188 is shaped to be generally rectangular. However, it should be appreciated that the at least one opening 188 can also be other shapes, including but not limited to, circular, oval, elliptical, etc. Further, if the central hub 186 has a plurality of openings 188, the openings 188 do not all have to be limited to one shape, but instead can each be one or more of a plurality of shapes, including but not limited to, rectangular, circular, oval, elliptical, etc. The at least one opening 188 functions in allowing air to enter and exit from the driven clutch. In certain embodiments, the at least one opening 188 allows air that enters the driven clutch from the outer face 124 of the opposing sheave 120 (not shown) to exit. As will be later illustrated with reference to FIGS. 11-13, the air received from the outer face 124 of the axially movable sheave 120, in certain embodiments, flows across the recess 128, subsequently exits through the bore 130 in the hub 126, and can be directed through the at least one opening 188 in the axially stationary sheave 180 and/or at the belt or area proximate to the belt.

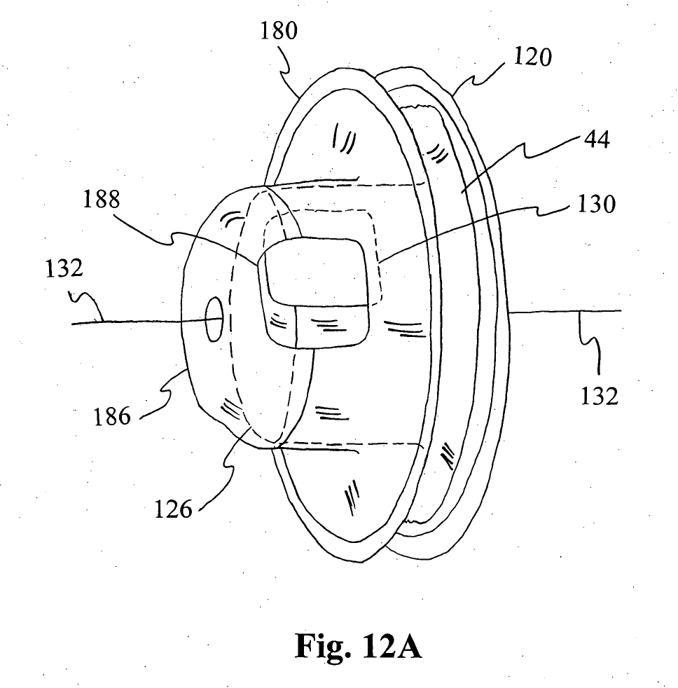

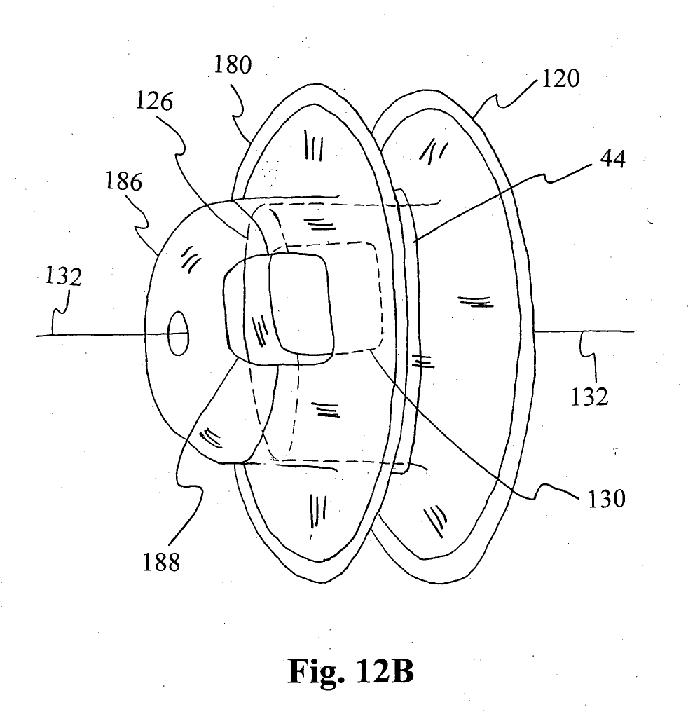

In certain embodiments, the positioning of the at least one opening 188 in the axially stationary sheave 180 is set so that whatever position the axially movable sheave 120 is in with respect to the axially stationary sheave 180, there is at least some overlap between the at least one bore 130 and at least one opening 188 respectively. As a result, air can flow from sheave to sheave, and as such, provide cooling for the clutch. In certain embodiments, air can flow from inside the axially movable sheave 120 to the outer face 184 of the axially stationary sheave 180. In certain other embodiments, air can flow from the outer face 124 of the axially movable sheave 120 to the outer face 184 of the axially stationary sheave 180. For example, as shown in FIG. 12A, in certain embodiments, when the axially moveable and axially stationary sheaves 120 and 180 are pulled together so that the at least one bore 130 of the axially movable sheave 120 is positioned within the central hub 186 of the axially stationary sheave 180 (and not exposed to the belt riding between the drive and driven clutches), the axially movable sheave 120 is said to be in a first axial position, with the at least one bore 130 and the at least one opening 188 partially overlapping.

Conversely, as the axially movable sheave 120 moves apart from the axially stationary sheave 180 and out of the first axial position, the at least one bore 130 moves axially away from such previously described overlap with the at least one opening 188. In addition, during such axial movement by the movable sheave 120, the movable sheave 120 also rotates with respect to the stationary sheave 180, causing the at least one bore 130 in the movable sheave 120 to also rotate with regard to the at least one opening 188 in the stationary sheave 180. In certain embodiments, the at least one opening 188 and the at least one bore 130 are originally provided in the sheaves 180 and 120 so that as the movable sheave 120 moves with respect to the stationary sheave 180, the at least one bore 130 and the at least one opening 188 still remain partially overlapped with respect to each other. For example, as shown in FIG. 12B, in certain embodiments, when the axially moveable sheave 120 is pulled apart from the axially stationary sheave 180, the axially movable sheave 120 is said to move out of the first axial position towards a second axial position. Once the axially movable sheave 120 pulls a certain distance away from the axially stationary sheave 180, so that the at least one bore 130 is partially exposed to the drive belt riding between the drive and driven clutches (where the at least one bore 130 aligns with the drive belt in a radial direction from the central axis of the driven clutch), the axially movable sheave 120 is said to be in a second axial position. In this second axial position, in certain embodiments, the at least one bore 130 and the at least one opening 188 are also partially overlapped.

In certain embodiments, no matter the distance of separation between the sheaves 120 and 180, during normal operation of the clutch, there is at least some overlap between the at least one bore 130 and the at least one opening 188 so that air can flow therebetween. As described before, in certain embodiments, air can be made to flow from one outer face of the sheave to the outer face of the other sheave, and as such, provide air circulation through the clutch, thereby cooling the clutch. When the axially moveable sheave 120 moves from a first axial position with the axially stationary sheave 180 toward a second axial position, the at least one bore 130 in the movable sheave 120 is generally slid out from underneath the hub 186 of the stationary sheave 180. As this occurs, the at least one bore 130 becomes at least partially exposed to the area between sheaves 120 and 180 and the drive belt riding between the drive and driven clutches. As such, by moving the movable sheave 120 from the first axial position to the second axial position, the at least one bore 130 in the movable sheave 120 is positioned to not only provide air circulation through the driven clutch, but also air circulation to the belt, as well as to the surrounding environment proximate to the belt.

In certain embodiments, one or more ribs 190 protrude from the outer face 184 of the axially stationary sheave 180, as illustrated in FIG. 11. In certain embodiments, each rib 190 has a design similar to the ribs 134 described above with respect to the axially movable sheave 120. As such, each rib 190 is a thin member having a length dimension 192 exceeding its width dimension 194, whereby the sheave 180 can accommodate many ribs 190, providing for a better heat sink for the sheave 180. The number of ribs 190 protruding from the sheave 180 can be varied as desired, and is dependent on the specific design of the sheave 180. In certain embodiments, the number of ribs 190 is at least about two; however, in other certain embodiments, the number of ribs 190 is at least about six. In further certain embodiments, the number of ribs 190 is at least about ten. During its typical use in the driven clutch of the CVT (not shown), the sheave 180 rotates in a counter-clockwise direction 196 as observed from the sheave's outer face 184. As the one or more ribs 190 extend radially from an inner radial edge 198 of the sheave 180 to an outer radial edge 200 of the sheave 180, at least one of the one or more ribs 190 generally curves away from the direction of rotation 196 of the sheave 180. In certain embodiments, each of the one or more ribs 190 generally curves away from the direction of rotation 196 of the sheave 180 in this fashion. Each of the one or more ribs 190 is generally a molded portion of the sheave 180, with an inner axial surface of each rib 190 being integrally joined with the outer face 184 of the sheave 180, and an outer axial surface of each rib 190 being exposed. In certain embodiments, the one or more ribs 190 each ramp from a maximum height at an inner radial end 202 (e.g., extending from the inner radial edge 198 of the sheave 180) down to a minimum height at an outer radial end 204 (e.g., extending to the outer radial edge 200 of the sheave 180).

If the outer face 184 of the sheave 180 has a plurality of ribs 190, in certain embodiments, the ribs 190 are spatially positioned around the sheave 180 in a windmill-like pattern, wherein each rib 190 is generally separated from adjacently-lying ribs 190 by a substantially equal sheave surface area. By their design, the one or more ribs 190 are adapted to direct air surrounding the outer face 184 of the sheave 180 inward, so that the air accumulates at an area proximate to a central area of the outer face 184 of the sheave 180. In certain embodiments, when the axially movable sheave 120 is in the second axial position with respect to the axially stationary sheave 180, the one or more ribs 190 direct air through the at least one opening 188 in the hub 186 of the sheave 180 to cool the clutch and/or the belt. At the same time, the design of the one or more ribs 190 also effectively reduces the wind drag that the ribs 190 experience when the sheave 180 rotates so as to increase the efficiency of the CVT. For example, when the CVT is engaged and the driven clutch rotates (with the axially stationary sheave 180 rotating in the counter-clockwise direction 192 as observed from the sheave's outer face 184), a leading surface 206 of each rib 190 makes contact with air located proximate to the outer face 184. However, because of their ramped height, the one or more ribs 190 experience minimum wind drag. At the same time, the one or more ribs 190, via their rotation and their curvature, naturally create an airflow for the air proximate to the outer face 184 of the sheave 180 so that the air is directed inward. In certain embodiments, as mentioned herein, the directed air is driven through the at least one opening 188 in the hub 126 of the sheave 120 to cool the clutch and/or the belt. As a result, the design of the ribs 190 generally provides a funneling of air inward while creating a minimum amount of wind drag on the sheave 180. Further, the wind drag exerted on the ribs 190 is less than what would normally be encountered with ribs that are axially (e.g., not ramped) or radially straight (e.g., not curved) in orientation, or ribs that generally curve into the direction of rotation 196 of the sheave 180. In summary, a driven clutch using the sheave 180 with the ribs 190 would be more aerodynamic, and as such, would rotate more efficiently, requiring less horsepower for rotation and exerting less stress on a corresponding CVT that the driven clutch is mounted onto.

FIG. 13 is an exploded perspective view of a driven clutch 208 of an exemplary embodiment of the invention utilizing the axially movable sheave 120 of FIG. 9, the plate 152 of FIG. 10, and the axially stationary sheave 180 of FIG. 11. When the driven clutch 208 is incorporated into a CVT, and the CVT is subsequently engaged, the driven clutch 208 rotates along with the drive clutch (not shown) and a belt (not shown) rides between the two clutches. With the rotation of the driven clutch 208, both the axially stationary sheave 180 and the axially movable sheave 120 generally rotate in unison. When the driven clutch 208 rotates, air surrounding the driven clutch 208, in particular with respect to the outer faces 124 and 184 of both the axially movable and axially stationary sheaves 120 and 180 respectively, are directed inward to areas central to the outer faces 124 and 184 of the sheaves 120 and 180 via the rotation of the ribs 134 and 194 on the sheaves 120 and 180, respectively. As previously described, air surrounding the outer face 124 of the movable sheave 120 is directed inward via the rotation of the ribs 134 and subsequently through the at least one aperture 168 defined by the plate 152 to cool the driven clutch 208. The fin design of the at least one aperture 168 causes the air to be directed through the at least one aperture 168, and in certain embodiments, across the recess 128 of the sheave 120 and through the at least one bore 130 present in the hub 126. As previously described, air surrounding the outer face 184 of the stationary sheave 180 is directed inward via the rotation of the ribs 194 and, in certain embodiments, through the at least one opening 188 to cool the driven clutch 208 and/or the belt. In addition, as the rotation of the drive clutch 208 is accelerated, the belt is pulled radially inward on the driven clutch assembly 208, causing the movable sheave 120 of the driven clutch 208 to move axially away from the stationary sheave 180. In turn, along with the air already being directed through the at least one aperture 168 of the plate 152 via the design of the one or more ribs 134 and the rotation of the sheave 120, when air surrounding the plate 152 on the movable sheave 120 comes into contact with air located proximate to the outer face 124 of the sheave 120, a portion of this air is also driven through the at least one aperture 168 and into the recess 128 of the sheave 120.

In certain embodiments, before the axially movable sheave 120 is pulled axially apart from the axially stationary sheave 180, the movable sheave 120 is in a first axial position, and the at least one bore 130 and the at least one opening 188 from the respective movable and stationary sheaves 120 and 180 are partially overlapped with respect to each other. With this overlap, the at least one bore 130 and the at least one opening 188 can provide an outlet for air internal to the driven clutch 208, an outlet for any air circulating from the outer face 124 of the axially movable sheave 120 through the driven clutch 208 (e.g., via the recess 128 of the sheave 120), and, in certain embodiments, an inlet for any air being directed via the rotation of the ribs 194 on the outer face 184 of the stationary sheave 180.

As the axially movable sheave 120 pulls away from the axially stationary sheave 180, the at least one bore 130 in the hub 126 of the movable sheave 120 generally is moved and rotated from its previously described overlap with the at least one opening 188 in the stationary sheave 180. In turn, the movable sheave 120 moves from the first axial position, and the bores 130 and openings 188 of the respective movable and stationary sheaves 70 and 120 also move with respect to each other. When the movable sheave 120 pulls far enough away from the stationary sheave 180 so that the at least one bore 130 is pulled out from underneath the hub 186 of the axially stationary sheave 180, the movable sheave 120 is in a second axial position. By the moveable sheave 120 moving from the first axial position to the second axial position, the bore 130 becomes exposed to the area between the sheaves 120 and 180 where the drive belt rides, and as such, provides air circulation to the area where the belt rides. As the amount of air accumulates in the area underneath the belt, the air begins to be driven outside the area. For example, air may pass between the belt and the inner faces of both sheaves 120 and 180. Thus, the air that is circulated from the outer face of the sheave 120, through the apertures 168 in the plate 152, and in certain embodiments, through the recess 128 and through the at least one bore 130 in the hub 126, may act to cool the belt as well as the environment proximate to the belt. With the movable sheave 120 being in the second axial position, in certain embodiments, the at least one bore 130 and the at least one opening 188 from the respective movable and stationary sheaves 120 and 180 are still at least partially overlapping each other. With this overlap, the at least one bore 130 and the at least one opening 188 can provide an outlet for air internal to the driven clutch 208, an outlet for any air circulating from the outer face 124 of the axially movable sheave 120 through the driven clutch 208 (e.g., via the recess 128 of the sheave 120), and an inlet for any air being directed via the rotation of the ribs 194 on the outer face 184 of the stationary sheave 180. In addition, the bore 130 provides an outlet for air to be circulated to the belt in order to cool the belt.

It should be appreciated that aspects of the ventilation systems described herein with respect to FIGS. 5-8 and with respect to FIGS. 9-13 can be combined to create other design variations of CVTs. For example, while in certain embodiments described above with respect to FIGS. 9-13, air is directed through the clutch by entering the at least one aperture 168 in the plate 152, continues through the hub 126, and exits through the at least one bore 130 in the hub 126, the air does not necessarily need to use the hub 128 as a general thoroughfare. Instead, in using the teachings with reference to FIGS. 5-8, the air may instead or in combination be funneled into a body of the axially movable sheave 70 with air channels connected to the bores 78. In certain embodiments, these air channels can be created provided in the interior wall of the hub 126. In other certain embodiments, the air channels can be provided in the outer face 124 of the shave 120. As such, still using the teachings with reference to FIGS. 9-13, one could have different and/or additional thoroughfares between the at least one aperture 168 in the plate 152 and the at least one bore 130 to provide further airflow through the at least one bore 130. Another example may involve the inner face 122 of the axially movable and the axially stationary sheaves 120 and 180 of FIGS. 9-13 having one or more recessed channels 100 (shown in FIG. 8) provided therein, which allow for the circulation of air around the sides of the endless belt that are in contact with the inner faces of the sheaves 120 and 180. A further example could involve modifying the plate 152 of FIGS. 9-13. The radius of the plate 152 can be enlarged to cover a larger portion of the outer face of the movable sheave 120. As such, the area outside of the recess 126 (e.g., the area generally containing ribs 134) would be covered by the plate 152, and a larger number of apertures 168 could be included in the plate 152 to additionally direct air to the air chambers (reference 88 in FIGS. 5-9) to directly cool the outer face 124 of the axially movable sheave 120. In addition, air channels 92 could be provided and connected between the air chambers 88 and the bores 78, so as to create different or additional thoroughfares between the at least one aperture 168 in the plate 152 and the at least one bore 130 to provide further airflow through the at least one bore 130.

While exemplary embodiments have been described, it should be understood that various changes, adaptations, and modifications may be made therein without departing from the spirit of the invention and the scope of the appended claims.

1. A continuously variable transmission comprising:
(a) a drive clutch rotatable about a first central axis and having an input shaft;
(b) a driven clutch rotatable about a second central axis and having an output shaft; and
(c) an endless belt disposed about the drive and driven clutches, the drive and driven clutches each being comprised of opposing sheaves including an axially stationary sheave and an axially movable sheave, each sheave having an inner face and an outer face, one of the sheaves being ventilated, the ventilated sheave having a central hub extending axially from an inner face of the ventilated sheave towards an inner face of an opposing sheave of the ventilated sheave, the central hub having at least one bore therein, the outer face of the ventilated sheave having a recess therein, a plate secured over the recess, the plate having at least one aperture therein, and a ventilation air path being defined through the plate via the at least one aperture and the ventilated sheave via the at least one bore.

2. The transmission of claim 1, wherein the at least one bore is defined in a surface of the central hub, and wherein the hub surface is aligned at an angle of between about 0° and about 45° relative to the central axis of the clutch containing the ventilated sheave.

3. The transmission of claim 1, wherein the at least one bore is oriented to permit airflow therethrough in a generally radial direction from the central axis of the clutch containing the ventilated sheave.

4. The transmission of claim 1, wherein the transmission comprises at least two bores, and wherein the at least two bores are symmetrically distributed at generally equal angles about the central axis of the clutch containing the ventilated sheave.

5. The transmission of claim 1, wherein the at least one aperture is defined in a major surface of the plate, and wherein the major surface is aligned at an angle of between about 45° and about 90° relative to the central axis of the clutch containing the ventilated sheave.

6. The transmission of claim 1, wherein the at least one aperture is oriented to permit airflow therethrough in an axial direction generally similar to the central axis of the clutch containing the ventilated sheave.

7. The transmission of claim 1, wherein the at least one aperture is adapted to direct air from an outer face of the plate through the at least one aperture, wherein the at least one aperture is partially defined by a leading surface leading the at least one aperture in a direction of rotation of the ventilated sheave, the leading surface extending being angled axially inwardly in a direction opposite the direction of rotation to form a ramped curvature.

8. The transmission of claim 1, wherein the plate is sized to substantially cover the recess.

9. The transmission of claim 1, wherein the ventilation air path is provided by way of the recess.

10. The transmission of claim 1, wherein the ventilation air path is provided by way of a body of the ventilated sheave.

11. The transmission of claim 1, wherein the ventilated sheave is adapted to move with respect to the opposing sheave, wherein the at least one bore of the ventilated sheave and at least one opening defined in the opposing sheave at least partially overlap in all movable positions of the opposing sheave relative to the ventilated sheave to provide a common airflow path through both the ventilated and opposing sheaves.

12. The transmission of claim 1, wherein the ventilated sheave is adapted to move with respect to the opposing sheave, and wherein a portion of the at least one bore aligns with the endless belt in a radial direction from the central axis of the clutch containing the ventilated sheave when the ventilated sheave is moved from a first axial position to a second axial position.

13. The transmission of claim 12, wherein the first axial position comprises the at least one bore of the ventilated sheave being positioned within a central hub of the opposing sheave and not being aligned with the endless belt in a radial direction from the central axis of the clutch containing the ventilated sheave.

14. The transmission of claim 1, wherein at least one of the ventilated and opposing sheaves has one or more ribs extending axially from the outer face thereof, and wherein the one or more ribs extend radially from an inner radial edge of the at least one sheave.

15. The transmission of claim 14, wherein the one or more ribs generally curve away from a direction of rotation of the at least one sheave, and wherein the one or more ribs are adapted to direct air inward to an area proximate to a central area of the outer face of the at least one sheave when the at least one sheave is rotated in the direction of rotation.

16. The transmission of claim 14, wherein the one or more ribs generally ramp axially in height from a maximum height at the inner radial edge of the at least one sheave to a minimum height at an outer radial edge of the at least one sheave, and wherein the one or more ribs are adapted to create a minimum amount of wind drag on the at least one sheave when the at least one sheave is rotated.

17. The transmission of claim 1, further comprising at least one recessed channel on an inner face of at least one of the ventilated and opposing sheaves, and wherein the at least one recessed channel is positioned so as to provide a passage for air to flow around a side of the endless belt in contact with the inner face of the at least one sheave.

18. The transmission of claim 1, wherein the ventilated sheave is part of the driven clutch.

19. The transmission of claim 1, wherein the ventilated sheave is axially moveable.

20. The transmission of claim 1, wherein the continuously variable transmission is utilized on a snowmobile.

21. A continuously variable transmission comprising:
(a) a drive clutch rotatable about a first central axis and having an input shaft;
(b) a driven clutch rotatable about a second central axis and having an output shaft; and
(c) an endless belt disposed about the drive and driven clutches, the drive and driven clutches each being comprised of opposing sheaves including an axially stationary sheave and an axially movable sheave, each sheave having an inner face and an outer face, one of the sheaves being ventilated, the ventilated sheave having one or more ribs extending axially from an outer face of the ventilated sheave, the one or more ribs generally curving away from a direction of rotation of the ventilated sheave as the one or more ribs extend in a radial direction from the central axis of the clutch containing the ventilated sheave, the curvature of the one or more ribs directing air radially inward along the outer face of the ventilated sheave to an area proximate to a central area of the outer face of the ventilated sheave when the ventilated sheave is rotated in the direction of rotation.

22. The transmission of claim 21, wherein the one or more ribs extend radially between an inner radial edge and an outer radial edge of the ventilated sheave.

23. The transmission of claim 21, wherein the one or more ribs comprise an inner radial end leading an outer radial end in the direction of rotation of the ventilated sheave.

24. The transmission of claim 21, wherein the one or more ribs comprise an inner radial end having a maximum height and an outer radial end having a minimum height, and wherein at least one of the one or more ribs are adapted to create a minimum amount of wind drag on the ventilated sheave when the ventilated sheave is rotated.

25. The transmission of claim 21, wherein the one or more ribs are symmetrically distributed on the ventilated sheave at generally equal angles about the central axis of the clutch containing the ventilated sheave.

26. The transmission of claim 21, wherein the ventilated sheave has a central hub extending axially from the inner face of the ventilated sheave towards the inner face of an opposing sheave of the ventilated sheave, and wherein the central hub has at least one bore therein.

27. The transmission of claim 26, further comprising a plate having at least one aperture therein, wherein the plate is located on the outer face of the ventilated sheave and secured over a recess defined by the outer face of the ventilated sheave, and wherein a ventilation air path is defined through the plate via the at least one aperture and the ventilated sheave via the at least one bore.

28. The transmission of claim 26, wherein the ventilated sheave is adapted to move with respect to the opposing sheave, wherein the at least one bore at least partially overlaps at least one opening defined in the opposing sheave regardless of the position of the ventilated sheave with respect to the opposing sheave, and wherein the overlap between the at least one bore and the at least one opening provide a ventilation air passageway between inside the ventilated sheave and the outer face of the opposing sheave.

29. The transmission of claim 26, wherein the ventilated sheave is adapted to move with respect to the opposing sheave, wherein a portion of the at least one bore aligns with the endless belt in a radial direction from the central axis of the clutch containing the ventilated sheave when the ventilated sheave is moved from a first axial position to a second axial position.

30. The transmission of claim 29, wherein the first axial position involves the at least one bore of the ventilated sheave being positioned within a central hub of the opposing sheave and not being aligned with the endless belt in a radial direction from the central axis of the clutch containing the ventilated sheave.

31. The transmission of claim 21, further comprising at least one recessed channel on an inner face of at least one of the ventilated and opposing sheaves, the at least one recessed channel positioned to provide a passage for air to flow around a side of the endless belt in contact with the inner face of the at least one sheave.

32. The transmission of claim 21, wherein the ventilated sheave is part of the driven clutch.

33. The transmission of claim 21, wherein the ventilated sheave is axially moveable.

34. The transmission of claim 21, wherein the continuously variable transmission is utilized on a snowmobile.

35. A continuously variable transmission comprising:
(a) a drive clutch rotatable about a first central axis and having an input shaft;
(b) a driven clutch rotatable about a second central axis and having an output shaft; and
(c) an endless belt disposed about the drive and driven clutches, the drive and driven clutches each being comprised of opposing sheaves including an axially stationary sheave and an axially movable sheave, each sheave having an inner face and an outer face, one of the clutches being ventilated, the axially movable sheave of the ventilated clutch permitting airflow therethrough via at least one bore therein, the axially stationary sheave of the ventilated clutch permitting airflow therethrough via at least one opening therein, the at least one bore of the axially movable sheave and the at least one opening of the axially stationary sheave at least partially overlapping in all movable positions of the axially moveable sheave relative to the axially stationary sheave to provide a common airflow path through both the axially movable and axially stationary sheaves.

36. The transmission of claim 35, wherein the axially movable sheave has a central hub extending axially from the inner face of the axially movable sheave towards the inner face of an opposing sheave of the axially movable sheave, and wherein the at least one bore is defined in the central hub.

37. The transmission of claim 36, further comprising a plate having at least one aperture therein, wherein the plate is located on an outer face of the axially movable sheave and secured over a recess defined by the outer face of the axially movable sheave, and wherein a ventilation air path is defined through the plate via the at least one aperture and the axially movable sheave via the at least one bore.

38. The transmission of claim 35, wherein the axially movable sheave is adapted to move axially with respect to the axially stationary sheave, wherein a portion of the at least one bore aligns with the endless belt in a radial direction from the central axis of the ventilated clutch when the axially movable sheave is moved from a first axial position to a second axial position.

39. The transmission of claim 38, wherein the first axial position comprises the at least one bore of the axially movable sheave being positioned within a central hub of the axially stationary sheave and not being aligned with the endless belt in a radial direction from the central axis of the ventilated clutch.

40. The transmission of claim 35, wherein at least one of the axially movable and axially stationary sheaves has one or more ribs, wherein the one or more ribs generally curve away from a direction of rotation of the at least one sheave as the one or more ribs extend in a radial direction from the central axis of the ventilated clutch, and wherein the curvature of the one or more ribs directs air inward to an area proximate to a central area of the outer face of the at least one sheave when the at least one sheave is rotated in the direction of rotation.

41. The transmission of claim 40, wherein the one or more ribs generally ramp axially in height from a maximum height at the inner radial edge of the at least one sheave to a minimum height at an outer radial edge of the at least one sheave, and wherein the one or more ribs are adapted to create a minimum amount of wind drag on the at least one sheave when the at least one sheave is rotated.

42. The transmission of claim 35, further comprising at least one recessed channel on an inner face of at least one of the axially movable and the axially stationary sheaves, the at least one recessed channel positioned to provide a passage for air to flow around a side of the endless belt in contact with the inner face of the at least one sheave.

43. The transmission of claim 35, wherein the ventilated clutch comprises the driven clutch.

44. The transmission of claim 35, wherein the continuously variable transmission is utilized on a snowmobile.

45. The transmission of claim 1, wherein the plate includes a central opening and an outer edge and wherein a plurality of apertures are formed in the plate between the central opening and the outer edge.

46. The transmission of claim 1, wherein the ventilated sheave has one or more ribs extending axially from the outer face thereof, the one or more ribs also extending radially outwardly from an inner portion of the ventilated sheave located adjacent the recess, the plate being sized to substantially cover the recess of the ventilated sheave while leaving the one or more ribs substantially exposed.

47. The transmission of claim 27, wherein the plate includes a central opening and an outer edge and wherein a plurality of apertures are formed in the plate between the central opening and the outer edge.

48. The transmission of claim 27, wherein the one or more ribs also extending radially outwardly from an inner portion of the ventilated sheave located adjacent the recess, the plate being sized to substantially cover the recess of the ventilated sheave while leaving the one or more ribs substantially exposed.

49. The transmission of claim 37, wherein the plaie includes a central opening and an outer edge and wherein a plurality of apertures are formed in the plate between the central opening and the outer edge.

50. The transmission of claim 37, wherein the axially movable sheave has one or more ribs extending axially from the outer face thereof, the one or more ribs also extending radially outwardly from an inner portion of the axially movable sheave located adjacent the recess, the plate being sized to substantially cover the recess of the axially movable sheave while leaving the one or more ribs substantially exposed.
